(19) United States
(12) Patent Application Publication
(10) Pub. No.: US 2026/0228344 A1
(43) Pub. Date: Aug. 6, 2026

(54) METHOD FOR AUTHENTICATING PHOTOS AND VIDEOS

(71) Applicant: BULL SAS, LES-CLAYES-SOUS-BOIS (FR)

(72) Inventor: Mikael LE BRIS, Le Sel de Bretagne (FR)

(73) Assignee: BULL SAS, LES-CLAYES-SOUS-BOIS (FR)

(21) Appl. No.: 19/401,373

(22) Filed: Nov. 26, 2025

(30) Foreign Application Priority Data
Dec. 11, 2024 (EP) 24307077.8

(51) Int. Cl. G06F 21/60

(52) U.S. Cl. CPC G06F 21/602

(57) ABSTRACT

One aspect of the invention relates to an image authentication method comprising:
Sending, by a computer to a server, an image to be authenticated and a first unique key previously obtained from the server,
Verifying, by the server, the authenticity of the image to be authenticated, based on the unique key, the image to be authenticated, and an image stored by the server that was registered when the unique key was obtained,
Receiving authenticity information from the server indicating whether the image to be authenticated is identical to the image stored by the server.

This application claims priority to European Patent Application Number 24307077.8, filed 11 Dec. 2024, the specification of which is hereby incorporated herein by reference.

### BACKGROUND OF THE INVENTION

### Field of the Invention

At least one embodiment of the invention is that of data authentication.

At least one embodiment of the invention relates to a method and a system for authenticating photos and videos so that a user can check whether a photo or video has been edited after prior registration.

### Description of the Related Art

In recent years, with the rapid growth and progress of Artificial Intelligence, a new process called “Deepfakes” has emerged. This process enables visual content to be generated using artificial intelligence (e.g. generative intelligence), making it possible to put real people in entirely fabricated situations, or to make them say words they never uttered. With Deepfakes, for example, it is possible to edit an existing video by replacing the face of one human being with the face of another. The same applies to voice, which can be replaced by the voice of someone else.

While this process can be useful for the production of cinematographic works, its use with public figures, and in particular political figures, poses significant problems. Indeed, such a procedure can damage a person's reputation, be a source of misinformation, or even create diplomatic incidents.

Several techniques have been developed to combat these practices. These techniques often use either artificial intelligence to detect defects in the content produced, or devices and methods directly integrated into the equipment used to capture the images.

Artificial intelligence solutions, for example, enable users to upload their videos to verify their authenticity. Editing is then performed on the video, and a report is provided with the areas affected. For example, these solutions can detect the fusion limit of deepfakes and provide a confidence score in return. However, the problem lies in the fact that generative artificial intelligence is advancing rapidly and is likely to surpass its shortcomings in the future. This will make detection by artificial intelligence techniques ever more complicated, energy-intensive and less reliable. What's more, these solutions often require manual action on the part of the user to download suspicious files, which assumes that the user is already suspicious about the content.

As far as hardware solutions are concerned, most are based on the insertion of cryptographic metadata when images are created or modified. This makes it possible to tag images as generated or modified by artificial intelligence, and track modifications. One problem is that solutions have to be implemented on a large scale on hardware, which requires collaboration between publishers and manufacturers and is complex to implement. Such collaborations can take a long time to set up, and can lead to situations of dependency between stakeholders.

There is therefore a need to propose a solution that does not possess the problems of the prior art, or limits them.

### BRIEF SUMMARY OF THE INVENTION

At least one embodiment of the invention offers a solution to the above-mentioned problems, by making it possible to

One aspect of one or more embodiments of the invention relates to an image authentication method comprising:
Sending, by a computer to a server, an image to be authenticated and a first unique key previously obtained from the server,
Verifying, by the server, the authenticity of the image to be authenticated, based on the unique key, the image to be authenticated, and an image stored by the server that was registered when the unique key was obtained,
Receiving authenticity information from the server indicating whether the image to be authenticated is identical to the image stored by the server.

At least one embodiment of the invention enables the authenticity of media (image or video) to be verified by sending the media and a previously obtained unique key to a server. The server then verifies authenticity by comparing the received media and key with a stored media and key. This ensures that any changes to the image after its initial registration can be detected. By using a unique key linked to both the media and the user, the method provides a robust mechanism for verifying media integrity.

In addition, in one or more embodiments, the method simplifies the user experience by automating the verification method, eliminating the need for manual intervention and reducing the potential for user error. This is particularly beneficial in scenarios where media authenticity is crucial, such as in the context of social media, journalism, or security.

In addition to the features mentioned in the preceding paragraph, the authentication method according to at least one embodiment of the invention may have one or more complementary features from the following, taken individually or according to all technically plausible combinations:
The method comprises beforehand:
Registering the image with the server, by a user of the computer, which registration comprises:
Sending, by the computer, the image to the server,
Storing, by the server, the image sent,
Calculating and storing the first unique key, by the server, the first unique key depending on information linked to the image and on information linked to the computer user,
Receiving from the server, by the computer, the first unique key.
the step of verifying the authenticity of the image to be authenticated comprises:
Calculating a second unique key, by the server, depending on information linked to the image to be authenticated and on information linked to the user of the computer,
Comparing the first unique key and the second unique key,
Comparing the image stored by the server with the image to be authenticated, and,
if the first unique key and the second unique key are identical, and the stored image and the image to be authenticated are identical, sending, by the server, authenticity information indicating that the second image is identical to the first image,
if the first unique key and the second unique key are different and/or the stored image and the image to be authenticated are different, sending, by the server, authenticity information indicating that the second image is different from the first image.
the first unique key and the second unique key are calculated by the server using the same calculation function, the calculation function taking as input the result of a hash function applied to an image and an item of information linked to the user, and providing as output a key.
the method is applied to a plurality of images making up a video registered with the server and then authenticated.
the video comprises an audio track, and wherein comparing the video stored by the server and the video to be authenticated comprises comparing the audio track of the video stored by the server and the audio track of the video to be authenticated.
the video to be authenticated comprises a plurality of videos registered separately with the server, and whereby verifying the authenticity of the video to be authenticated by the server is repeated for each video of the plurality of videos.
After receiving the first unique key, the method comprises a step of storing the first unique key in the video.
the first public key is stored in a “udta” field of the video in MPEG-4 Part 14 format.

At least one embodiment of the invention relates to a system configured to implement the method according to one or more embodiments of the invention, the system comprising:
The computer and
The server.

In at least one embodiment, the computer implements a website configured to access the server via an application programming interface. The website can be configured to publish the image registered with the server with the first unique key that is associated with it. The website can also be configured to implement the method before publishing an image or video, and the website can be configured to publish the authenticity information received from the server with the image or video.

Another aspect of one or more embodiments of the invention relates to a computer program product comprising instructions which, when the program is executed by a computer, lead the computer to implement the method according to at least one embodiment of the invention.

Another aspect of one or more embodiments of the invention relates to a computer-readable medium on which the computer program product according to at least one embodiment of the invention is stored.

The at least one embodiment of the invention and its different applications will be better understood upon reading the following disclosure and examining the accompanying figures.

### BRIEF DESCRIPTION OF THE DRAWINGS

The figures are presented by way of reference and are in no way limiting to the one or more embodiments of the invention.

FIG. 1 shows a schematic depiction of a method according to one or more embodiments of the invention,

FIG. 2 shows a schematic depiction of a system for implementing the method according to one or more embodiments of the invention,

FIG. 3 shows a schematic depiction of a first phase of the method according to one or more embodiments of the invention,

FIG. 4 shows a schematic depiction of a second phase of the method according to one or more embodiments of the invention,

FIG. 5 shows a schematic depiction of a second phase of the method according to one or more embodiments of the invention,

FIG. 6 shows a schematic depiction of one example of the method according to one or more embodiments of the invention by a website.

### DETAILED DESCRIPTION OF THE INVENTION

Unless otherwise stated, the same element appearing in different figures has the same reference.

At least one embodiment of the invention relates to a method and system for authenticating images, enabling image authentication with a server, after the image has been registered with the server. At least one embodiment of the invention also applies to a plurality of images, which can be authenticated independently of one another, or in groups of images, or even when the plurality of images form a video, in which case the at least one embodiment of the invention enables the video to be authenticated.

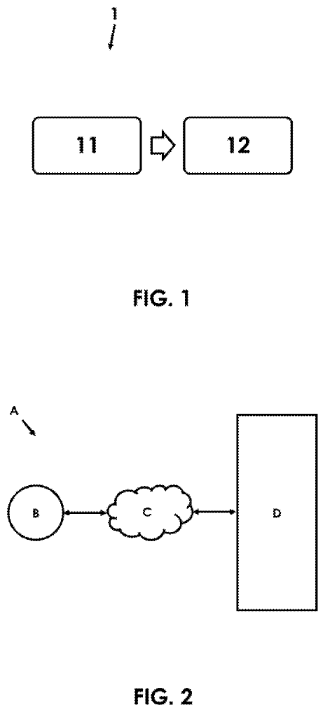

To this end, at least one embodiment of the invention relates in particular to a method 1 shown in FIG. 1. This method 1 comprises a first phase 11 of registering the image(s) or video(s) with the server, followed by a second phase 12 of verifying the authenticity of the image(s) or video(s) previously registered with the server. The at least one embodiment of the invention is by no means limited to the one or more embodiments described below. In particular, the at least one embodiment of the invention makes it possible to authenticate an image, a plurality of images, a video and/or a plurality of videos.

The method 1 can be implemented by a system A shown schematically in FIG. 2, according to one or more embodiments of the invention. The system A comprises a computer B connected to a server D via a network C. The network C is, for example, a network based on the Internet protocol suite. Of course, the server D is also a computer. The server D is called a “server” because it is configured to receive a request from computer A and to respond to it. To achieve this, the server D may, for example, include an Application Programming Interface (API), which enables a computer to interact with the server D via a computer-implemented program. The at least one embodiment of the invention also covers any other way of interacting with the server D.

“Computer” means a physical device comprising at least one processor and a memory, configured to implement a method. A computer is “configured to implement a method” when the computer's memory stores instructions which, when executed by the computer's processor, lead the processor and therefore the computer to implement the method. Similarly, the server D is a computer, and therefore a physical device.

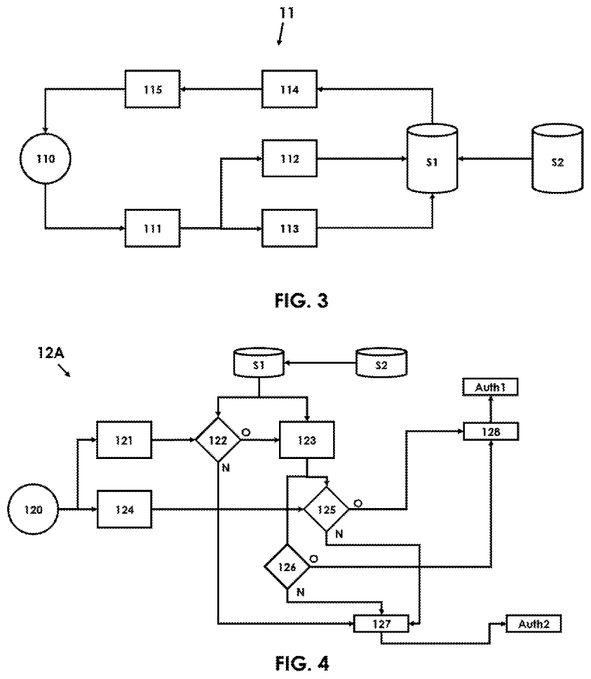

The method 1 comprise a first phase of registration 11. An example of the first phase of registration 11 is shown schematically in FIG. 3. In at least one embodiment, the example of an image will be taken, but the at least one embodiment of the invention is not limited to the registration of an image, and can apply in the same way to the registration of a video, of a plurality of images in a single registration, or by repeating the registration for each image of the plurality of images, or of a plurality of videos in a single registration or by repeating the registration for each video of the plurality of videos.

The registration phase 11 enables the server D to familiarize itself with the media to be authenticated later, by storing it, and to familiarize itself with the user associated with that media.

Thus, the registration phase 11 comprises a first step 110 of connecting the user U to the server D via the computer B. For example, the user U can connect to the server D via a login interface, such as a username/password combination. The computer B can be stand-alone, and connect to the server D via a program, with the login credentials of the user U stored on it.

Once the user U is logged in to the server, that is authenticated to the server D as a user of the method for authenticating images and/or videos, the registration phase 11 comprises a step 111 in which the computer B sends an authentic image to the server D. This is done via the network C. The image sent is an authentic image. An “authentic image” is an image to be stored by the server D, which will serve as the basis for authenticating a subsequent image during the authentication phase. The subsequent image to be authenticated is then compared with the authentic image, and it is checked whether the subsequent image is identical to the registered image. In other words, verifying the authenticity of a subsequent image comprises checking that the subsequent image is not the result of an alteration of the authentic image.

The authentic image sent in step 111 is then stored by the server D in a memory S1 in step 112. This memory S1 is for example a read-only memory, for example internal to the server D, or can be accessed by the server D via a network.

The registration phase 11 then comprises a step 113 of calculating and storing, by the server D, a unique key, the unique key depending on information linked to the authentic image and information linked to the user U of the computer B that had submitted the authentic image. FIG. 3 shows that the unique key generated in this way is stored in memory S1, but the unique key can also be stored in any other memory.

To generate the unique key, the server D uses its processor and calculates the result of a computation function taking as input information linked to the authentic image and information linked to the user U who submitted the authentic image. For example, the calculation function can be a simple concatenation of the two pieces of information. To obtain the information linked to the user U, the processor can access a memory S2 storing information on users of the image and/or video authentication process. Another possibility is that the memory S1 and the memory S2 are combined. The information linked to the image is the result of a hash function applied to the authentic image.

To calculate the information linked to the image, the hash function is, for example, MD5 (“Message Digest Algorithm 5”), SHA (“Secure Hash Algorithm”), BLAKE, CRC (Cyclic Redundancy Code) or any other known hash function.

The hash function takes the authentic image as input. Preferentially, the entire authentic image is provided as input to the hash function.

In addition, the calculation function takes as input information linked to the user U, for example a unique identifier for the user U.

The unique key is therefore a concatenation of the hashed image and an item of information linked to the user. This unique key is then stored by the server D.

Once the unique key has been calculated by server D, it is encrypted in step 114, to obtain a signed unique key, and then transmitted to computer B in step 115, where it is received by computer B. The user U then has the encrypted unique key and can attach it to his authentic image, and share the authentic image with his encrypted unique key. The unique key can be encrypted in any way known to the person skilled in the art, for example by asymmetric encryption, symmetric encryption, AES (Advanced Encryption Standard), or any other known encryption method.

The encrypted unique key can be attached to the content, for example by inserting it in the “udta” field of the video in MPEG-4 Part 14 format, when the authentic content is a video.

Once the registration phase 11 has been completed, the method 1 comprises an authentication phase 12. The registration phase 11 must be implemented for each authentic image and/or video that will later be authenticated 12 with the server D. The authentication phase 12 may be implemented by a different computer from the computer B that initiated the registration phase 11, or it may be the same computer B. To implement an authentication phase 12 for a given image to be authenticated, it is necessary for the “authentic” version of this image to have been registered during a registration phase 11 with the server D. The “authentic version” of an image to be authenticated is the image registered with the server, which will be used as a basis for comparison to check whether the image to be authenticated is indeed the authentic image, or whether the image to be authenticated has been altered or is different from the authentic image.

FIG. 4 shows a schematic representation of at least one embodiment 12A of the authentication phase 12, wherein an image is being authenticated, according to one or more embodiments of the invention.

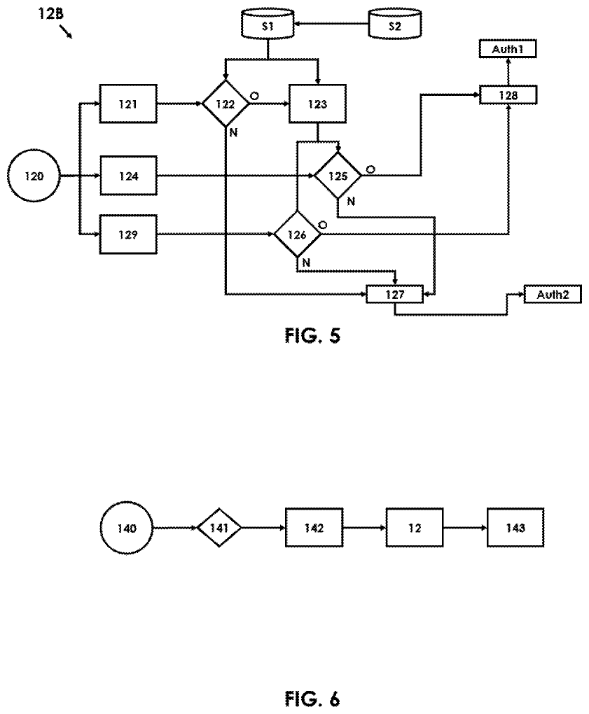

FIG. 5 shows a schematic representation of at least one embodiment 12B of the authentication phase 12, wherein a video is being authenticated, according to one or more embodiments of the invention.

In at least one embodiment of the authentication phase 12A, a computer (e.g. computer B) sends an image to be authenticated and a unique encrypted key of the authentic image associated with the image to be authenticated, in a step 120. In other words, the user U wants to know whether the image to be authenticated is the authentic image associated with the encrypted unique key he has attached to the image to be authenticated. This encrypted unique key sent in step 120 is an encrypted unique key received from server D during the phase 11 of registering the authentic image associated with the image to be authenticated.

This sending in step 120 can, for example, be carried out using an application programming interface (API) of the server D.

Once the image to be authenticated and the encrypted unique key have been sent, the authenticity of the image to be authenticated is verified by the server D, using the encrypted unique key, the image to be authenticated, and the authentic image stored by the server D and retrieved from the encrypted unique key.

In order to carry out this authenticity check, the encrypted unique key is decrypted in step 121 by the server D, using a decryption method that decrypts content encrypted by the encryption method used in the registration phase 11.

Once the unique key has been decrypted, the server D checks whether this key exists, that is whether this key can be accessed in memory by the server D. At step 122, the server D checks whether this unique key received corresponds to a key stored by the server D in memory S1 or accessible by the server D in memory S1. If this key exists (“O” in FIG. 4), a step 123 is then performed. If this key does not exist (“N” in FIG. 4), a step 127 is then performed.

The step 123 is a step of retrieving the unique key stored in memory S1 and the authentic image stored in memory S1, corresponding to the unique key attached to the image to be authenticated sent in step 120. In step 123, the result of the hash function included in the unique key is extracted from the unique key, and will be used in step 125, as described later.

In step 124, from the image to be authenticated sent in step 120, a new hash function result is calculated by the server D. Thus, the image to be authenticated is hashed with the same hash function as that used in step 113 of the registration phase 11.

Step 125 is therefore a step of comparing the results of the hash functions applied respectively to the image to be authenticated and to the authentic image, the result of the hash function applied to the image to be authenticated coming from step 124 and the result of the hash function applied to the authentic image coming from step 123. Comparing the results of hash functions makes it possible to compare images as such, and therefore to check whether their contents (i.e. the digital data that make them up, representing each pixel) are identical. In step 125, the results of the hash functions are checked for equality. If they are equal (“O” in FIG. 4), a step 128 is performed. If this are not (“N” in FIG. 4), a step 127 is performed.

In step 126, the authentic image recovered in step 123 is compared with the image to be authenticated. Such a comparison can be a pixel-by-pixel comparison, or a comparison performed by machine learning, for example by deep learning such as a neural network. In this way, it is checked whether the images are identical and, if so (“O” in FIG. 4), a step 128 is performed. If this are not (“N” in FIG. 4), a step 127 is performed.

This authenticity information is sent by the server D to the computer that performed the 120 sending step. If this are not (“N” in FIG. 4), a step 127 is performed.

The image to be authenticated is considered authentic (“Auth1”), and this authenticity information is sent by the server D to the computer that performed the step of sending 120.

Step 127 is an “OR” operator, receiving the information that the unique key does not exist in memory S1, the information that the results of the hash functions applied to the image to be authenticated and to the authentic image are not equal, and the information of the images to be authenticated and authentic image are not equal. If one of these three items of information is true, the image to be authenticated is considered to be non-authentic (“Auth2”), and this non-authenticity information is sent by the server D to the computer that performed the sending step 120.

Step 128 is an “AND” operator, receiving the information that the unique key does exist in memory S1, the information that the results of the hash functions applied to the image to be authenticated and to the authentic image are equal, and the information of the images to be authenticated and authentic image are equal. If these three items of information are true, the image to be authenticated is considered to be authentic (“Auth1”), and this authenticity information is sent by the server D to the computer that performed the sending step 120.

Thus, the only case that results in “Auth1” verified authentication is the case wherein:
the unique key is retrieved from memory S1 and
the results of the hash functions applied to the image to be authenticated and to the authentic image are equal, and
the images are identical.

Verified authentication means that the image to be authenticated is identical to the authentic image stored by the server.

In at least one embodiment 12B shown schematically in FIG. 5, a video is authenticated, whereas in the at least one embodiment 12A, an image was authenticated.

The at least one embodiment 12B comprises the same steps 121 to 128 as the at least one embodiment 12A, and comprises an additional step 129. In fact, in the case of video authentication, the same steps of verifying the existence of the unique key in memory S1 and comparing the results of the hash functions applied to the video to be authenticated and to the authentic video are carried out.

The difference between an image and video is that video can contain a soundtrack. Thus, the authentication phase then comprises extracting the soundtrack of the video to be authenticated in a step 129, and comparing the soundtrack of the video to be authenticated and the soundtrack of the authentic video stored by memory S1 is performed, in addition to comparing the images of the video, in step 126. The soundtrack of the authentic video is extracted, for example, in step 123, which retrieves the video from memory S and the unique key from memory S1.

One or more embodiments of the invention can also be implemented for videos that contain a plurality of videos and/or images to be authenticated. In such a case, it can be envisaged that the server D is configured to extract from the video the various components to be authenticated, and to perform the authentication phase 12 for each component of the video. For example, a video comprising a plurality of videos and/or images to be authenticated can be sent in step 120 with all the unique keys associated with the components of the video to be authenticated, for example by dividing the video into time intervals, each time interval corresponding to a component of the video to be authenticated and being associated with a unique key. The authentication phase is then carried out for each component on each time interval, and authentication information can be provided by the server D for each component, or for the whole video, if all the components are authentic.

By way of one or more embodiments of the invention, shown in FIG. 6, compatible with previous one or more embodiments, the computer B implements a website, for example a social network or a multimedia content website, and automatically manages the authenticity of the content that is shared on that website. To achieve this, a method 14 shown in FIG. 6 is implemented.

First, in step 140, a website user uploads new media to the website, that is an image or video.

The website is then configured to check, at step 141, whether a unique encrypted key is attached to the content. If it is, the website is configured to perform a step 142 of requesting the server D to verify the authenticity of the downloaded media, by attaching the encrypted unique key. The server D then performs the authentication phase 12, for example according to the at least one embodiment 12A if the media is an image, or according to at least one embodiment 12B if the media is a video.

In step 143, the website receives the authenticity information from the media and displays it together with the media when it is published on the website. In particular, this alerts website users to the authenticity of the media displayed, thus solving the technical problem of verifying media authenticity.

When the media is reposted by a website user, it is also possible for the website to check whether an item of content authenticity authentication has already been obtained, and to carry out procedure 14 if this it has not. If an item of content authenticity information has already been obtained, this information is displayed alongside the content on the user's repost of the media.

1-15. (canceled)

16. A method for authenticating images comprising:
sending, by a computer to a server, an image to be authenticated and a first unique key previously obtained from the server,
verifying, by the server, authenticity of the image to be authenticated, based on the first unique key, the image to be authenticated, and an image stored by the server that was registered when the first unique key was obtained,
receiving authenticity information from the server indicating whether the image to be authenticated is identical to the image stored by the server.

17. The method according to claim 16, comprising beforehand:
registering the image with the server, by a user of the computer, wherein said registering comprises:
sending, by the computer, the image to the server,
storing, by the server, the image that is sent,
calculating and storing the first unique key, by the server, the first unique key depending on information linked to the image and on information linked to the user of the computer,
receiving from the server, by the computer, the first unique key.

18. The method according to claim 17, wherein the verifying the authenticity of the image to be authenticated comprises:
calculating a second unique key, by the server, depending on information linked to the image to
be authenticated and on information linked to the user of the computer,
comparing the first unique key and the second unique key,
comparing the image stored by the server with the image to be authenticated, and,
if the first unique key and the second unique key are identical, and the image that is stored and the image to be authenticated are identical, sending, by the server, authenticity information indicating that the image to be authenticated is identical to the image that is stored,
if the first unique key and the second unique key are different and/or the image that is stored and the image to be authenticated are different, sending, by the server, authenticity information indicating that the image to be authenticated is different from the image that is stored.

19. The method according to claim 18, wherein the first unique key and the second unique key are calculated by the server using a same calculation function, the same calculation function taking as input a result of a hash function applied to an image and an item of information linked to the user, and providing as output a key.

20. The method according to claim 16, whereby the method is applied to a plurality of images constituting a video registered with the server and then authenticated.

21. The method according to claim 20, wherein the video comprises an audio track, and wherein comparing the video stored by the server and the video to be authenticated comprises comparing the audio track of the video stored by the server and the audio track of the video to be authenticated.

22. The method according to claim 20, wherein the video to be authenticated comprises a plurality of videos registered separately with the server and wherein verifying the authenticity of the video to be authenticated by the server is repeated for each video of the plurality of videos.

23. The method according to claim 20, further comprising, after receiving the first unique key, storing the first unique key in the video.

24. The method according to claim 23, wherein the first unique key is stored in a “udta” field of the video in MPEG-4 Part 14 format.

25. A system comprising:
a computer, and
a server,
wherein the system is configured to implement a method for authenticating images comprising
sending, by a computer to a server, an image to be authenticated and a first unique key previously obtained from the server,
verifying, by the server, authenticity of the image to be authenticated, based on the first unique key, the image to be authenticated, and an image stored by the server that was registered when the first unique key was obtained,
receiving authenticity information from the server indicating whether the image to be authenticated is identical to the image stored by the server.

26. The system according to claim 25, wherein the computer implements a website configured to access the server via an application programming interface.

27. The system according to claim 26, wherein the website is configured to publish the image that is registered with the server with the first unique key that is associated with it.

28. The system according to claim 26, wherein the website is configured to implement the method prior to publishing an image or video, and wherein the website is configured to publish the authenticity information received from the server with the image or video.

29. A computer program product comprising instructions that, when the computer program product is executed by a computer, lead the computer to implement a method for authenticating images comprising
sending, by the computer to a server, an image to be authenticated and a first unique key previously obtained from the server,
verifying, by the server, authenticity of the image to be authenticated, based on the first unique key, the image to be authenticated, and an image stored by the server that was registered when the first unique key was obtained,
receiving authenticity information from the server indicating whether the image to be authenticated is identical to the image stored by the server.

30. The computer program product according to claim 29, wherein the computer program product is stored on a non-transitory computer-readable medium.
